(19) United States
(12) Patent Application Publication
(10) Pub. No.: US 2020/0084299 A1
(43) Pub. Date: Mar. 12, 2020

(54) CONTROL SYSTEM, TRANSMITTER, AND RECEIVER SYSTEM

(71) Applicant: PANASONIC INTELLECTUAL PROPERTY MANAGEMENT CO., LTD., Osaka (JP)

(72) Inventors: Yushi NAKAMURA, Osaka (JP); Masato HANASHIMA, Hyogo (JP); Takefumi INOUE, Nara (JP)

(21) Appl. No.: 16/462,886

(22) PCT Filed: Nov. 17, 2017
(86) PCT No.: PCT/JP2017/041458

§ 371 Date: May 21, 2019

Related U.S. Application Data
(60) Provisional application No. 62/424,993, filed on Nov. 21, 2016.

(51) Int. Cl. H04L 29/06; H04L 12/28; G08C 17/02

(52) U.S. Cl. CPC H04L 69/08; H04L 12/282; H04L 12/2814; H04L 69/16; H04L 12/2834; G08C 17/02; H04L 12/2836

(57) ABSTRACT

The control system includes a transmitter, and a receiver system. The transmitter includes a manual operation unit and is configured to, when the manual operation unit is operated, cause self-power generation to send an operation signal via wireless communication. The receiver system is configured to, when receiving the operation signal via wireless communication, control a plurality of target devices associated with the operation signal.

### TECHNICAL FIELD

The present disclosure generally relates to control systems, transmitters, and receiver systems and in particular to a control system for controlling a plurality of target devices, and a receiver system suitable for the control system.

### BACKGROUND ART

Patent Literature 1 discloses a system (control system) for providing a smart space. The system of Patent Literature 1 includes a hub and a plurality of peripheral devices (target devices) which are in communication with each other. In this system, the hub controls each peripheral device. However, in Patent Literature 1, to control each peripheral device, a user is required to interact with the hub via a local or wide network by use of a computer equipped with applications. Therefore, the user has to take very troublesome procedure.

One of objects of the present disclosure would be to propose a control system, a transmitter, and a receiver system which enables control of a plurality of target devices in response to just single operation by a user.

### CITATION LIST

### Patent Literature

Patent Literature 1: US 2016/0139575 A1

### SUMMARY OF INVENTION

A control system according to one aspect of the present disclosure includes a transmitter and a receiver system. The transmitter includes a manual operation unit and is configured to, when the manual operation unit is operated, cause self-power generation to send an operation signal via wireless communication. The receiver system is configured to, when receiving the operation signal via wireless communication, control a plurality of target devices associated with the operation signal.

A transmitter according to one aspect of the present disclosure includes a manual operation unit and is configured to, when the manual operation unit is operated, cause self-power generation to send an operation signal via wireless communication.

A receiver system according to one aspect of the present disclosure is configured to, when receiving an operation signal via wireless communication, control a plurality of target devices associated with the operation signal.

### BRIEF DESCRIPTION OF DRAWINGS

FIG. 1 is a schematic diagram of a control system of one embodiment.

FIG. 2 is a block diagram of a transmitter of the above control system.

FIG. 3 is a perspective section of the transmitter.

FIG. 4 is a section of the transmitter, wherein the transmitter is not operated.

FIG. 5 is a section of the transmitter, wherein the transmitter is operated.

FIG. 6 is a block diagram of a receiver of the control system.

FIG. 7 is a block diagram of a target device to be controlled by the control system.

FIG. 8 is a block diagram of an information terminal of the control system.

FIG. 9 is a sequence diagram of the control system.

### DESCRIPTION OF EMBODIMENTS

1. Embodiments

1.1 Overview

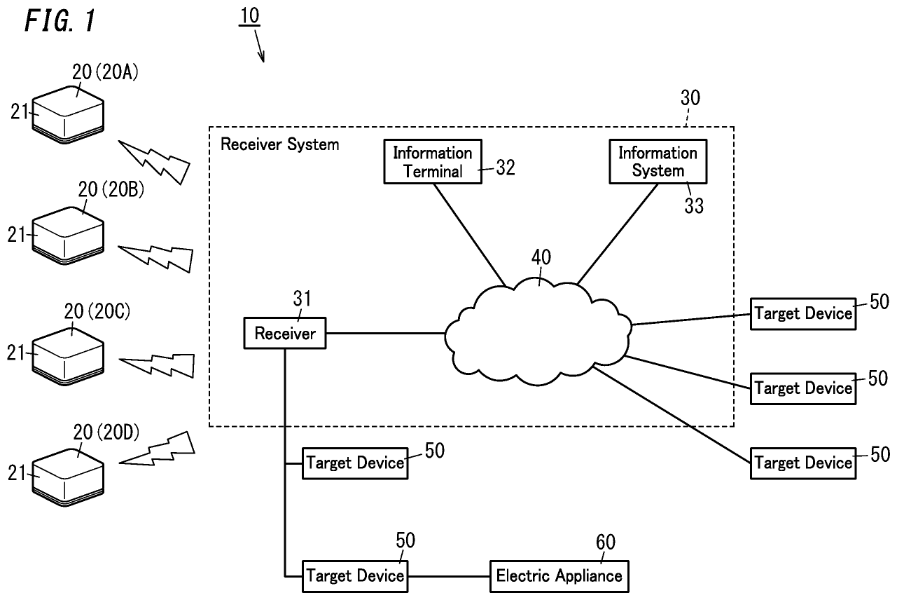

As shown in FIG. 1, a control system 10 of the present embodiment includes a transmitter 20 and a receiver system 30. The transmitter 20 includes a manual operation unit 21 and is configured to, when the manual operation unit 21 is operated, cause self-power generation to send an operation signal via wireless communication. The receiver system 30 is configured to, when receiving the operation signal via wireless communication, control a plurality of target devices 50 associated with the operation signal.

In the control system 10, the transmitter 20 sends an operation signal in response to operation on the manual operation unit 21, and the receiver system 30 controls the plurality of target devices 50 in response to the operation signal. In summary, the control system 10 enables control of the plurality of target devices 50 in response to single operation by a user. Especially, since the transmitter 20 causes self-power production to send an operation signal, there is no need to connect the transmitter 20 to a power supply. Additionally, since the transmitter 20 sends an operation signal via wireless communication, there is no need to make wired communication with the receiver system 30. Consequently, a user can situate the transmitter 20 in a desired position.

1.2 Configurations

Hereinafter, the control system 10 of the present embodiment is further described in detail. As shown in FIG. 1, the control system 10 includes a plurality of (four in FIG. 1) transmitters 20, and a receiver system 30. In the following, the plurality of the transmitter 20 are distinguished from one other by use of reference signs 20A, 20B, 20C, and 20D, if necessary.

The transmitters 20 are installed in facilities managed by a user. For example, the facilities may be a single dwelling. Note that, examples of the facilities may include multiple dwellings (dwelling units, common use spaces), stores, and office buildings (entire buildings, floors), in addition to single dwellings. Further, the facilities may not be limited to a house or building, but may include a house or building together with its land such as factories, parks, hospitals, and commerce facilities.

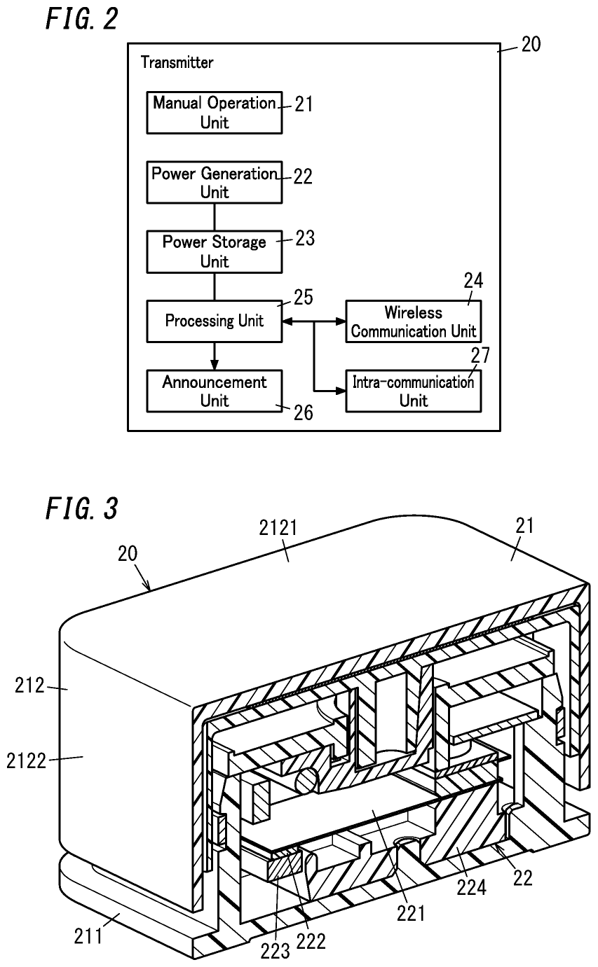

The plurality of transmitters 20 have the same configuration. As shown in FIG. 2, each transmitter 20 includes a manual operation unit 21, a power generation unit 22, a power storage unit 23, a wireless communication unit 24, a processing unit 25, an announcement unit 26, and an intra-body communication unit 27.

The manual operation unit 21 is a unit to be operated by a user. In the present embodiment, as shown in FIG. 3, the manual operation unit 21 also serves as a housing of the transmitter 20. The transmitter 20 is a so-called physical button.

The manual operation unit 21 accommodates the power generation unit 22, the power storage unit 23, the wireless communication unit 24, the processing unit 25, the announcement unit 26, and the intra-body communication unit 27 therein. In the present embodiment, the transmitter 20 (the manual operation unit 21) has a user portable size. Thus, a user can put the transmitter 20 in a desired position. For example, the transmitters 20A and 20D are located in a bedroom, and the transmitters 20B and 20C are located at an entrance. Note that, the transmitter 20 may not be always fixed, but may be just put on an object such as furniture. Further, the transmitter 20 may be fixed to a wall.

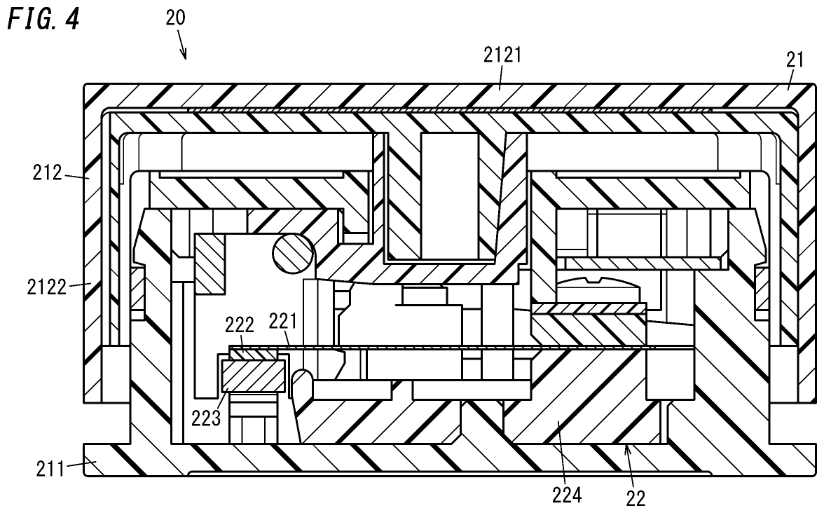

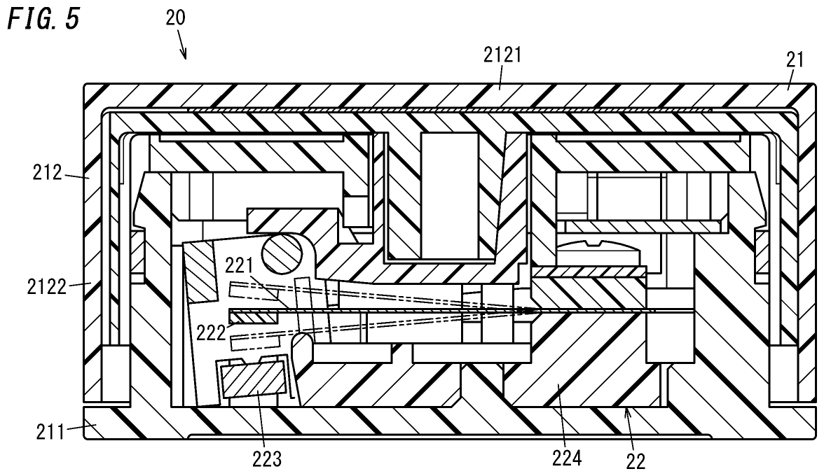

As shown in FIG. 3 to FIG. 5, the manual operation unit 21 includes a body 211 and a cover 212. The body 211 has a cuboidal box shape with an opening located in one surface in its thickness direction (upper surface in FIG. 4 and FIG. 5). The body 211 accommodates the power generation unit 22, the power storage unit 23, the wireless communication unit 24, the processing unit 25, the announcement unit 26, and the intra-body communication unit 27. The cover 212 includes: a flat plate 2121 which has a rectangular shape and covers the opening of the body 211; and a surrounding wall 2122 protruding from a periphery of the flat plate 2121 to surround the body 211. The cover 212 is attached to the body 211 to be movable in the thickness direction of the body 211. In particular, the cover 212 is movable between a first position (see FIG. 4) and a second position (see FIG. 5). The first position is longer in a distance between the flat plate 2121 of the cover 212 and a bottom of the body 211 than the second position. In simple terms, pushing the flat plate 2121 of the cover 212 in the first position toward the body 211 moves the cover 212 from the first position to the second position. In other words, the phrase “the user operates the manual operation unit 21” may be read as “the user moves the cover 212 of the manual operation unit 21 from the first position to the second position”. Note that, the body 211 and the cover 212 each have electrically insulating properties. For example, the body 211 and the cover 212 are molded products of resin material with electrically insulating properties.

The power generation unit 22 is configured to generate power for operating the transmitter 20 when the manual operation unit 21 is operated. As shown in FIG. 3 to FIG. 5, the power generation unit 22 includes a piezoelectric device 221, a weight 222, a magnet 223, and a holder 224. The piezoelectric device 221 is used to convert mechanical energy produced when the manual operation unit 21 is operated, into electric energy. Use of the piezoelectric device 221 may improve power generation efficiency in the transmitter 20. The piezoelectric device 221 has a rectangular plate shape. The weight 222 is magnetic and is fixed to a first end in a length direction of the piezoelectric device 221 (left end in FIG. 4 and FIG. 5). The holder 224 holds the piezoelectric device 221 at a second end in the length direction of the piezoelectric device 221 (right end in FIG. 4 and FIG. 5). Further, the holder 224 holds the magnet 223 movably between a contact position and a separate position. The contact position is a position where the magnet 223 is in contact with the weight 222 due to magnetic force, as shown in FIG. 4. The separate position is a position where the magnet 223 is separate from the weight 222, as shown in FIG. 5. The holder 224 puts the magnet 223 in the contact position while no load is given. For example, the holder 224 keeps the magnet 223 in the contact position by elastic material or the like.

The power generation unit 22 is accommodated in the manual operation unit 21. In this regard, the magnet 223 of the power generation unit 22 is held in the contact position while the cover 212 of the manual operation unit 21 is in the first position. When the cover 212 of the manual operation unit 21 is moved from the first position to the second position, the magnet 223 is moved from the contact position to the separate position. In movement of the magnet 223 from the contact position to the separate position, the weight 222 is pulled by the magnet 223 and then the piezoelectric device 221 is bent. At last, the weight 222 is separated from the magnet 223. Due to this, as shown in FIG. 5, the piezoelectric device 221 vibrates. This vibration causes mechanical energy, this mechanical energy is converted into electric energy, and this electric energy is outputted from the piezoelectric device 221.

In summary, when a user pushes or presses the cover 212 of the manual operation unit 21, the cover 212 is moved from the first position to the second position, accompanied by the magnet 223 of the power generation unit 22 being moved from the contact position to the separate position. As a result, the piezoelectric device 221 vibrates and then electric energy is outputted from the power generation unit 22.

The power storage unit 23 is configured to store electric energy generated by the power generation unit 22. Electric energy stored in the power storage unit 23 is used to operate the wireless communication unit 24, the processing unit 25, the announcement unit 26, and the intra-body communication unit 27 of the transmitter 20. In summary, the transmitter 20 operates with electric energy stored in the power storage unit 23. The power storage unit 23 may be one or more capacitors.

The wireless communication unit 24 includes a communication interface for wireless communication with the receiver system 30. Examples of standards of wireless communication may include standards of Bluetooth (registered trademark) and near field communication (NFC).

The announcement unit 26 is provided to give announcement to a user. The announcement unit 26 includes a buzzer as means for giving audio announcement, for example.

The intra-body communication unit 27 includes a communication interface for intra-body communication. The intra-body communication unit 27 is configured to receive identification information (user identification information) from a dedicated device worn by a user via intra-body communication. The intra-body communication unit 27 enables identification of a person who operates the transmitter 20. In the present embodiment, when the manual operation unit 21 is operated by a user, the intra-body communication unit 27 receives the user identification information via intra-body communication. Such a dedicated device for intra-body communication may be conventional and well-known, and detailed explanation thereof may be omitted.

The processing unit 25 is a circuit for controlling operation of the transmitter 20. The processing unit 25 may be realized by a computer system including one or more processors (microprocessors) and one or more memories, for example. Therefore, the one or more processors execute one or more programs stored in the one or more memories to function as the processing unit 25. In this regard, such one or more programs may be stored in the one or more memories of the processing unit 13 in advance, or may be provided through telecommunication circuits such as the Internet, or may be provided with being recorded in one or more non-transitory recording media readable by computer systems such as memory cards.

The processing unit 25 is activated to start its operation when electric energy stored in the power storage unit 23 has amount equal to or larger than a predetermined value. The processing unit 25 stops its operation when electric energy stored in the power storage unit 23 has amount smaller than the predetermined value. When starting its operation, the processing unit 25 sends an operation signal from the wireless communication unit 24. In the present embodiment, the operation signal includes identification information of the transmitter 20 (transmitter identification information) and identification information (user identification information) received by the intra-body communication unit 27. Further, the processing unit 25 is configured to operate the announcement unit 26 when receiving a response signal from the receiver system 30 via the wireless communication unit 24.

As described above, the transmitter 20 includes the manual operation unit 21, and is configured to, when the manual operation unit 21 is operated, cause self-power generation to send an operation signal via wireless communication. Further, the transmitter 20 is configured to, when receiving identification information via intra-body communication, send the identification information via wireless communication.

Note that, the power generation unit 22 and the power storage unit 23 of, the transmitter 20 are configured to allow the processing unit 25 to send an operation signal in response to manual operation on the manual operation unit 21, and to allow the announcement unit 26 to operate in response to a response signal from the receiver system 30.

As shown in FIG. 1, the receiver system 30 includes a receiver 31, an information terminal 32, and an information system 33. The receiver 31, the information terminal 32, and the information system 33 are connectable to a network 40. Note that, the receiver 31, the information terminal 32, and the information system 33 are connected to each other via the network 40 at least when the receiver system 30 operates, but may not be always required to be connected to each other via the network 40.

The network 40 may be constituted by a network in conformity with a single communication protocol or multiple networks in conformity with different communication protocols. Such a communication protocol may be selected form various wired and wireless communication standards. Examples of wireless communication protocols may include standards for specified low power radio stations and wireless local area (LAN) networks. Examples of the wireless LAN standards may include Wi-Fi (registered trademark). In FIG. 1, the network 40 is simplified but may include data communication devices such as repeater hubs, switching hubs, bridges, gateways, and routers.

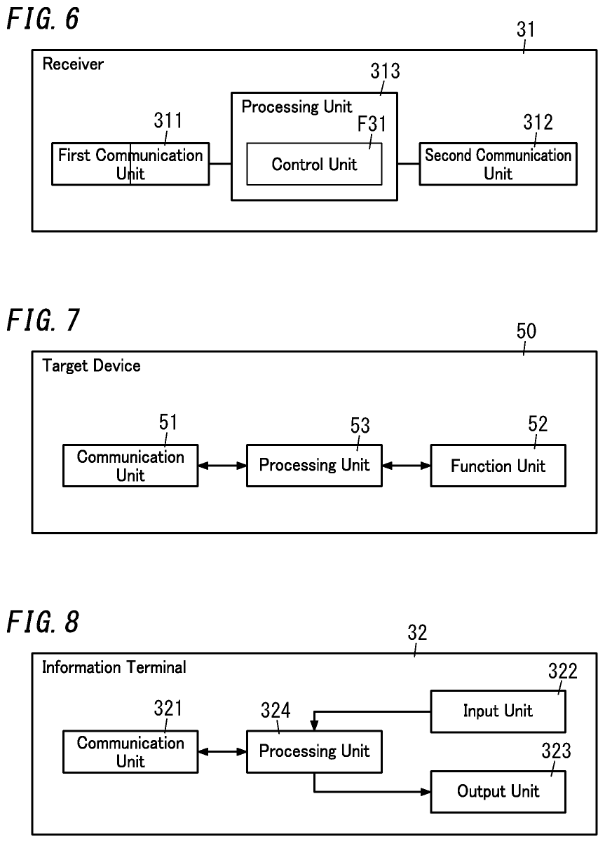

As shown in FIG. 6, the receiver 31 includes a first communication unit 311, a second communication unit 312, and a processing unit 313.

The first communication unit 311 includes a communication interface for wireless communication with the transmitter 20. Examples of standards of wireless communication may include standards of Bluetooth and near field communication. In the present embodiment, prior to using the transmitter 20, pairing between the transmitter 20 and the receiver 31 is done. For example, such pairing between the transmitter 20 and the receiver 31 may be made by sending an operation signal from the transmitter 20 while the receiver 31 is in a pairing mode. Note that, such pairing may be achieved by a conventional method, and therefore detailed explanation thereof may be omitted.

The second communication unit 312 includes a communication interface for communicating with the information terminal 32, the information system 33, and the target devices 50. The second communication unit 312 may be directly connected to the information terminal 32, the information system 33, and the target devices 50 or indirectly connected to them via the network 40 (see FIG. 1).

The processing unit 313 includes a circuit for controlling operation of the receiver 31. Especially, the processing unit 313 includes a control unit F31 configured to control the plurality of target devices 50. Note that, the control unit F31 represents not a tangible configuration but a function achieved by the processing unit 313. This processing unit 313 may be realized by a computer system including one or more processors (microprocessors) and one or more memories, for example. Therefore, the one or more processors execute one or more programs stored in the one or more memories to function as the processing unit 313. In this regard, such one or more programs may be stored in the one or more memories of the processing unit 313 in advance, or may be provided through telecommunication circuits such as the Internet, or may be provided with being recorded in one or more non-transitory recording media readable by computer systems such as memory cards.

The following explanation is made to the target devices 50 which are devices to be controlled by the control system 10. The target devices 50 may be installed in facilities managed by a user, similarly to the transmitter 20.

As shown in FIG. 7, each target device 50 includes a communication unit 51, a function unit 52, and a processing unit 53.

The communication unit 51 includes a communication interface for communicating with the receiver 31. The communication unit 51 may be directly connected to the receiver 31 without using the network 40 or indirectly connected to it via the network 40.

The function unit 52 includes a mechanical structure for realizing a predetermined function in relation to the target devices 50. The functions realized by the function units 52 may be different mainly depending on types of target devices 50. Examples of categories of target devices 50 may include sensor related devices, air conditioning related devices, homes and facilities related devices, cooking and chores related devices, management and control related devices, and AV related devices. Examples of the sensor related devices may include a human detection sensor. Examples of the air conditioning related devices may include air conditioning devices, fans, ventilators, and air purifiers. Examples of the homes and facilities related devices may include electric shades (smart shades), electric curtains (smart curtains), and lights (smart lights and smart bulbs). Examples of the cooking and chores related devices may include microwave ovens, automatic cooker (e.g., smart coffee makers, and toasters), and automatic cleaners (smart cleaners). Examples of the management and control related devices may include smartphones, controllers, switches, smart wall switches, smart plugs, security cameras, and smart thermostats. Examples of the AV related devices may include television sets, displays, and audio equipment (e.g., music players and smart speakers).

For example, when a target device 50 is an air conditioner, the function unit 52 includes mechanical structures for realizing functions of the air conditioner (e.g., condensers, evaporators, compressors, temperature sensors, and the like). When a target device 50 is an electric curtain, the function unit 52 includes mechanical structures for realizing functions of the electric curtain (e.g., curtains, a mechanism for opening and closing the curtains, and the like). When a target device 50 is an automatic cleaner, the function unit 52 includes mechanical structures for realizing the automatic cleaner (e.g., a suction mechanism, a moving mechanism, and the like). When a target device 50 is a switch, the function unit 52 includes mechanical structures for realizing the switch (e.g., contacts, a switching mechanism, connectors, and the like). In one case where the target device 50 is a switch, an electric appliance 60 may be connected to the target device 50, as shown in FIG. 1. In this case, the target device 50 can control the electric appliance 60. Note that, the mechanical structures of the function unit 52 may be conventional, and therefore detailed explanation thereof may be omitted. Similarly to the target devices 50, examples of the electric appliance 60 may include sensor related devices, air conditioning related devices, homes and facilities related devices, cooking and chores related devices, management and control related devices, and AV related devices.

The processing unit 53 includes a circuit for controlling operation of the target device 50. Especially, the processing unit 53 has a function of controlling the function unit 52 in response to a control signal given by the control unit F31. This processing unit 53 may be realized by a computer system including one or more processors (microprocessors) and one or more memories, for example. Therefore, the one or more processors execute one or more programs stored in the one or more memories to function as the processing unit 53. In this regard, such one or more programs may be stored in the one or more memories of the processing unit 53 in advance, or may be provided through telecommunication circuits such as the Internet, or may be provided with being recorded in one or more non-transitory recording media readable by computer systems such as memory cards.

Next, the control unit F31 is further described in detail. The control unit F31 is configured to control the plurality of target devices 50 when the manual operation unit 21 of the transmitter 20 is operated by a user.

The control unit F31 is configured to, when receiving an operation signal from the transmitter 20 via the first communication unit 311, obtain control information of the target devices 50 with reference to correspondence relation information. Note that, the correspondence relation information may be stored in the one or more memories of the processing unit 53.

In the correspondence relation information, one or more pieces of the control information are associated with one or more pieces of the transmitter identification information. In the correspondence relation information of the present embodiment, for each piece of the user identification information, one or more pieces of the control information are associated with one or more pieces of the transmitter identification information. The control information contains: pieces of identification information of a plurality of target devices 50 (pieces of device identification information) to be controlled in response to an operation signal; and pieces of information indicative of contents of control of the plurality of target devices 50 (pieces of content information). Further, the control information contains information indicative of order of control of the plurality of target devices 50 identified by pieces of the device identification information (order information).

Further, in the correspondence relation information, transmitter identification information is associated with a valid time period. The valid time period indicates a time period for accepting an operation signal. Thus, the control unit F31 is configured to, only when receiving an operation signal from the transmitter 20 within a time period corresponding to the operation signal (the valid time period), control a plurality of target devices 50 associated with the operation signal. Hence, when a time of reception of an operation signal is not included in the valid time period of the operation signal, the control unit F31 ignores the operation signal received. Operation on the transmitter 20 out of a time period within which operation on the transmitter 20 is supposed to be done may be wrong operation. Setting such a valid time period can reduce probability that the plurality of target devices 50 are controlled in response to wrong operation on the transmitter 20.

The following Table 1 and Table 2 indicate pieces of the correspondence relation information for different users. In Table 1 and Table 2, only for facilitating understanding of explanation, reference signs 20A to 20D of the transmitters shown in FIG. 1 are described as corresponding pieces of the transmitter identification information, and types of target devices 50 are described as corresponding pieces of the device identification information. Further, in Table 1 and Table 2, the order information indicates delay time from a time point of start of control. One of main purposes of setting such delay time may be to make operations of desired target devices 50 complete at the same time. In Table 2, there is a difference of two minutes between delay time of the toaster and the coffee maker. This is to make the toaster and the coffee maker complete their preparations at the same time in consideration of a difference between a time at which the toaster completes its preparation and a time at which the coffee maker completes its preparation.

TABLE 1

| | Control Information | | | |
|---|---|---|---|---|
| Transmitter | Device | Content | Order | Valid |
| Identification | Identification | Infor- | Infor- | Time |
| Information | Information | mation | mation | Period |
| 20A | Light in Living | On | 0 | 4:00-6:00 |
| | Room | | | |
| | Electric | Open | 0 | |
| | Curtain/Shade | | | |
| | Smartphone | Obtaining | 0 | |
| | | Weather Report | | |
| | Coffee Maker | On | 0 | |
| | Air Conditioner | On | 0 | |
| 20B | Light in Living | Off | 0 | 5:00-7:00 |
| | Room | | | |
| | Switch in | Off | 0 | |
| | Bedroom | | | |
| | Electric | Close | 0 | |
| | Curtain/Shade | | | |
| | TV/Audio | Off | 0 | |
| | Air Conditioner | Off | 0 | |
| | Automatic | On | 0 | |
| | Cleaner | | | |
| 20C | Light in Living | On | 0 | 16:00-18:00 |
| | Room | | | |
| | Electric | Close | 0 | |
| | Curtain/Shade | | | |
| | Smartphone | Notifications of | 0 | |
| | | Return | | |
| | Air Conditioner | On | 0 | |
| 20D | Light in Living | Off | 0 | 22:00-24:00 |
| | Room | | | |
| | Switch in | Off | 0 | |
| | Bedroom | | | |
| | Electric | Close | 0 | |
| | Curtain/Shade | | | |
| | Smartphone | Turn off | 0 | |
| | | Notifications | | |

TABLE 2

| | Control Information | | | |
|---|---|---|---|---|
| Transmitter | Device | Content | Order | Valid |
| Identification | Identification | Infor- | Infor- | Time |
| Information | Information | mation | mation | Period |
| 20A | Light in Living | On | 0 | 6:00-8:00 |
| | Room | | | |
| | Smartphone | Turn off | 0 | |
| | | Alarms | | |
| | Toaster | On | 2 minutes | |
| | Coffee Maker | On | 4 minutes | |
| | Loudspeaker | Play Music | 0 | |
| 20B | Light in Living | Off | 0 | 7:00-10:00 |
| | Room | | | |
| | Air Conditioner | Off | 0 | |
| | Loudspeaker | Stop Music | 0 | |
| 20C | Light in Living | On | 0 | 18:00-22:00 |
| | Room | | | |
| | Air Conditioner | On | 0 | |
| | Loudspeaker | Play Music | 0 | |
| 20D | Light in Living | Off | 0 | 23:00-26:00 |
| | Room | | | |
| | Air Conditioner | On | 0 | |

Examples of scenes of using the transmitter 20 may include a bedroom when a user wakes up, an entrance when a user goes out, a living room when a user comes back, and a bedroom when a user goes sleeping. In the pieces of the correspondence relation information shown in Table 1 and Table 2, the transmitter 20A is supposed to be used in the bedroom when a user wakes up. The transmitter 20B is supposed to be used at the entrance when a user goes out. The transmitter 20C is supposed to be used in the living room when a user comes back. The transmitter 20D is supposed to be used in the bedroom when a user goes sleeping.

The control unit F31 is configured to, when obtaining the control information corresponding to an operation signal, send controls signals corresponding to pieces of content information to a plurality of target devices 50 identified by the control information through the second communication unit 312 in order identified by the order information. As a result, each of the plurality of target devices 50 operates in accordance with a control signal received. Therefore, use of the order information allows controlling the plurality of target devices 50 at timings desired by a user.

Additionally, the control unit F31 is configured to, when receiving an operation signal through the first communication unit 311, send a response signal through the first communication unit 311 to the transmitter 20 which is a source of the operation signal. Accordingly, the transmitter 20 can confirm receipt of the operation signal.

As shown in FIG. 8, the information terminal 32 includes a communication unit 321, an input unit 322, an output unit 323, and a processing unit 324. For example, the information terminal 32 may be a smartphone. Note that, the information terminal 32 may be realized by a mobile terminal such as a table, or a personal computer (especially, a laptop computer).

The communication unit 321 enables communication via the network 40. The communication unit 321 conforms to a communication protocol corresponding to communication via the network 40.

The input unit 322 includes an input device and a microphone for manually operating the information terminal 32. The input device may include a touch pad and/or one or more buttons, for example. The output unit 323 includes an output device for displaying information, and a loudspeaker. The output device includes a display (e.g., a liquid crystal display), for example. Note that, the touch pad of the input unit 322 and the display of the output unit 323 may constitute a touch panel.

The processing unit 324 is a circuit for controlling operation of the information terminal 32. The processing unit 324 has a function of setting the correspondence relation information to which the control unit F31 refers. In more detail, the processing unit 324 makes the output device of the output unit 323 display a screen for inputting the correspondence relation information by use of the input unit 322. Therefore, a user can input the correspondence relation information by use of the information terminal 32. The processing unit 324 sends the correspondence relation information inputted by the user to the receiver 31 via the network 40. As a result, the correspondence relation information of the receiver 31 is changed. This processing unit 324 may be realized by one or more processors (microprocessors) and one or more memories, for example. Therefore, the one or more processors execute one or more programs stored in the one or more memories to function as the processing unit 324. For example, installed in the information terminal 32 is dedicated application software including one or more programs for setting the correspondence relation information. When the processing unit 324 of the information terminal 32 activates the application software, the processing unit 324 enables setting of the correspondence relation information.

The information system 33 is a system for obtaining desired information. For example, the information system 33 is used to provide information available for control of the target devices 50, to the receiver 31. The information system 33 may be implemented by one or more servers, or a cloud computing system, for example.

For example, the information system 33 may provide reference information (e.g., time information, weather information, . . . , and GPS information) to the control unit F31. In this case, the control unit F31 can reflect the reference information on control of the target devices 50. For example, when the target device 50 is a smartphone or a loudspeaker, it is possible to provide a message to a user by use of the reference information. For example, by use of the time information and the GPS information, it is possible to obtain weather information regarding a user's location. When the weather information indicates that the weather is rain, it is possible to provide a user with a message prompting the user to bring an umbrella when going out. By referring to that reference information, operation suitable for a usage environment of the target devices 50 is enabled.

The information system 33 may collect operational states of the target devices 50. For example, the information system 33 may obtain operational states of the target devices 50 and provide them to the receiver 31. In this case, the control unit F31 is allowed to easily control the plurality of target devices 50 in the order identified by the order information.

The information system 33 may store history information of manual operation of the transmitter 20 by a user (manual operation history information) and history information of operation of the target devices 50 (operation history information). The manual operation history information (scene log) may be an indicator for learning which scene and when a user selects. The operation history information (device operation log) may be an indicator for learning what operation and when a user requests the target devices 50 to do. In view of the above, the information system 33 may the control information suitable for a user automatically by use of the manual operation history information and the operation history information as well as a learned model, for example. For example, when a user inputs the correspondence relation information by the information terminal 32, it is possible to present the control information to the user. Or, the information system 33 may set a valid time period for the transmitter 20 automatically by use of the manual operation information and the operation information. As described above, the information system 33 can propose the control information and/or the valid time period automatically, and thus the control system 10 can become user-friendly.

1.3 Operation

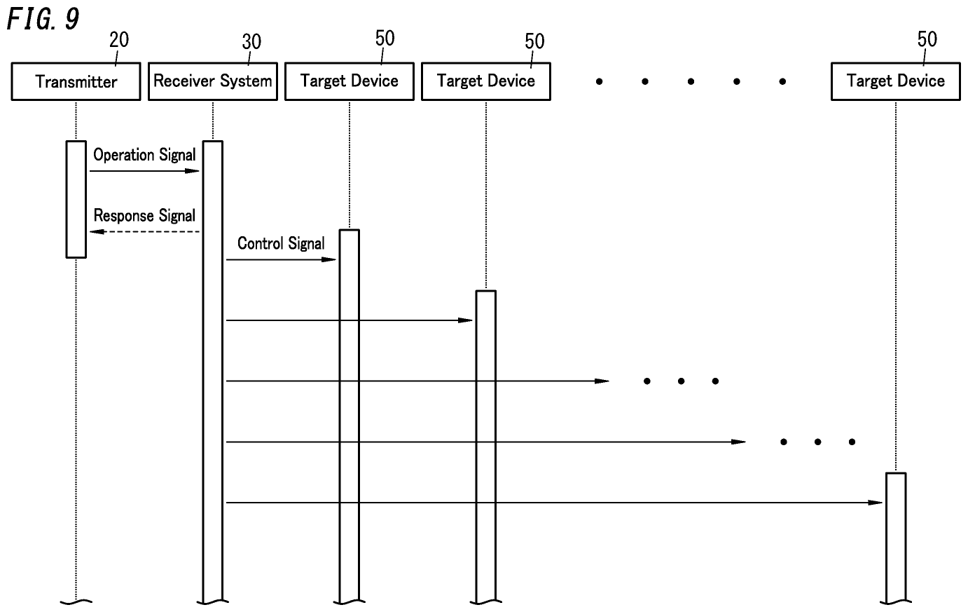

Hereinafter, operation of the control system 10 is described briefly with reference to FIG. 9. First of all, in the initial state, the control system 10 stores the correspondence relation information including contents indicated by Table 1 and Table 2. The contents of Table 1 correspond to user identification information of a user A and the contents of Table 2 correspond to user identification information of a user B.

When the user A wakes up and operates the manual operation unit 21 of the transmitter 20A, the transmitter 20A causes self-power generation and sends the operation signal (see FIG. 9). This operation signal includes the user identification information of the user A and the transmitter identification information of the transmitter 20A. When receiving the operation signal, the receiver 31 of the receiver system 30 sends the response signal to the transmitter 20A (see FIG. 9). When receiving the response signal, the transmitter 20A activates the announcement unit 26 to give announcement.

Further, the receiver 31 obtains the valid time period from the correspondence relation information based on the user identification information and the transmitter identification information of the operation signal, and determines whether the time of reception of the operation signal falls within the valid time period. When the time of reception of the operation signal falls within the valid time period, the receiver 31 obtains the control information from the correspondence relation information. And, the receiver 31 sends the control signals corresponding to the content information included in the control information to the plurality of target devices 50 identified by the device identification information included in the control information based on the order information included in the control information (see FIG. 9). According to Table 1, the light in the living room is turned on, the electric curtain/shade is opened, the smartphone obtains weather information, the coffee maker is turned on, and the air conditioner is turned on. The user A is allowed to control various target devices 50 by just operating the transmitter 20A.

As described above, according to the control system 10, control of the plurality of target devices 50 to be performed by a user at a predetermined timing every day can be done by operating just one transmitter 20. Such everyday routine work can be done by simple operation. Therefore, time for everyday routine work can be reduced, and a user can use his or her time more effectively.

2. Variations

The aforementioned embodiment is just one of various embodiments in relation to the present disclosure. The aforementioned embodiment may be modified in various ways in accordance with design or the like, as long as it also can achieve the object of the present disclosure. Hereinafter, variations of the above embodiment are listed.

The manual operation unit 21 is a physical button and includes a mechanism of a so-called push switch but may not be limited to this. The manual operation unit 21 may apply a mechanism such as a toggle switch, a slide switch, and a rotary switch, for example. Further, an outer shape of the manual operation unit 21 may not be limited to a rectangular shape but may be a circular shape or a polygonal shape (e.g., a triangle shape).

The announcement unit 26 may be configured to give announcement by use of light or vibration, instead of announcement by sound. Of course, the announcement unit 26 may be configured to give announcement by use of two or more of sound, light and vibration. The announcement by light may be realized by lighting a luminaire such as a light emitting diode, for example. The announcement by vibration may be realized by driving a motor, for example. Or, the transmitter 20 may not include the announcement unit 26.

The transmitter 20 may not include the intra-body communication unit 27. Especially, the intra-body communication unit 27 may be omitted if there is no need to identify a user operating the transmitter 20. In summary, in the correspondence relation information, the user identification information may be optional.

For example, the receiver 31 may be embedded in or retrofitted to a personal computer. For example, the receiver 31 may be connected to a USB terminal of a personal computer and thus the personal computer may be used as part of the network 40. Note that, the receiver 31 may be a stand-alone device.

The correspondence relation information may not be limited to examples shown in Table 1 and Table 2. Especially, the control information may be set or changed in accordance with user's demand. For example, in terms of the transmitter 20 which is to be operated when a user comes back, it is possible to associate therewith the control information with contents that the electric curtain/shade is closed, lighting tone is adjusted, room temperature is adjusted, music is played, and an important mail is read out. In terms of the transmitter 20 which is to be operated when a user goes out, it is also possible to associate therewith the control information with contents that all of the target devices 50 are turned off. Note that, regarding the correspondence relation information, valid time periods may be optional.

In the above embodiment, the order information indicates delay time, but may indicate just the order. For example, when the target device 50 being a light is first and the target devices 50 being an audio is second, the receiver system 30 may send a control signal to the target device 50 being a light and thereafter send a control signal to the target devices 50 being an audio. In this case, it is optional to confirm whether the target devices 50 being a light starts operation according to a control signal. In summary, in the control system 10, the plurality of target devices 50 may not necessarily operate simultaneously. To meet user's preference, at least some of the plurality of target devices 50 may operate in predetermined order.

The control system 10 according to the present disclosure includes a computer system. The computer system includes main hardware components including one or more processors and one or more memories. The one or more processors execute one or more programs recorded in the one or more memories of the computer system, thereby functioning as the control system 10 according to the present disclosure. Such one or more programs may be stored in the one or more memories of the computer system in advance, or may be provided through telecommunication circuits, or may be provided with being recorded in one or more non-transitory recording media readable by computer systems. Examples of the non-transitory recording media readable by computer systems may include memory cards, optical disks, and hard disk drive. A processor of such a computer system may include one or more electronic circuits including a semiconductor integrated circuit (IC) or a large scale integrated circuit (LSI). The electronic circuits may be aggregated into one chip, or distributed to chips. The chips may be aggregated into one device, or distributed to devices. Alternatively, at least one of functions of the control system 10 (e.g., the control unit F31) may be realized by a server, a cloud (cloud computing), or the like.

3. Aspects

As apparent from the aforementioned embodiment and variations, a first aspect is a control system (10) including: a transmitter (20, 20A to 20D) and a receiver system (30). The transmitter (20, 20A to 20D) includes a manual operation unit (21) and configured to, when the manual operation unit (21) is operated, cause self-power generation to send an operation signal via wireless communication. The receiver system (30) is configured to, when receiving the operation signal via wireless communication, control a plurality of target devices (50) associated with the operation signal. Accordingly, the first aspect enables control of a plurality of target devices (50) in response to just single operation by a user.

A second aspect is a control system (10) which would be realized in combination with the first aspect. In the second aspect, the receiver system (30) includes: a receiver (31) configured to receive an operation signal from the transmitter (20, 20A to 20D); and a server or a cloud computing system connected to the receiver (31) via a network (40). Accordingly, the second aspect enables obtainment of desired information (e.g., information available for control of the target devices (50)).

A third aspect is a control system (10) which would be realized in combination with the first or second aspect. In the third aspect, the transmitter (20, 20A to 20D) includes a piezoelectric device (221) configured to convert mechanical energy produced when the manual operation unit (21) is operated, into electric energy. Accordingly, the third aspect enables improvement of power generation efficiency of the transmitter (20, 20A to 20D).

A fourth aspect is a control system (10) which would be realized in combination with any one of the first to third aspects. In the fourth aspect, the receiver system (30) is configured to control the plurality of target devices (50) in a predetermined order. Accordingly, the fourth aspect enables the plurality of target devices (50) to be controlled at timings desired by a user.

A fifth aspect is a control system (10) which would be realized in combination with any one of the first to fourth aspects. In the fifth aspect, the receiver system (30) is configured to, only when receiving an operation signal from the transmitter (20, 20A to 20D) within a valid time period corresponding to the operation signal, control a plurality of target devices (50) associated with the operation signal. Accordingly, the fifth aspect can reduce probability that the plurality of target devices (50) are controlled in response to wrong operation of the transmitter (20, 20A to 20D).

A sixth aspect is a control system (10) which would be realized in combination with any one of the first to fifth aspects. In the sixth aspect, the transmitter (20, 20A to 20D) is configured to, when receiving identification information via intra-body communication, send the identification information via wireless communication. Accordingly, the sixth aspect enables identification of a person who has operated the transmitter (20, 20A to 20D).

A seventh aspect is a transmitter (20, 20A to 20D) including a manual operation unit (21) and configured to, when the manual operation unit (21) is operated, cause self-power generation to send an operation signal via wireless communication. Accordingly, the seventh aspect enables control of a plurality of target devices (50) in response to just single operation by a user.

An eight aspect is a receiver system (30) configured to, when receiving an operation signal via wireless communication, control a plurality of target devices (50) associated with the operation signal. Accordingly, the eight aspect enables control of a plurality of target devices (50) in response to just single operation by a user.

### REFERENCE SIGNS LIST

10 Control System

20, 20A, 20B, 20C, 20D Transmitter

21 Manual Operation Unit

22 Power Generation Unit

23 Power Storage Unit

24 Wireless Communication Unit

25 Processing Unit

26 Announcement Unit

27 Intra-body communication Unit

30 Receiver System

31 Receiver

32 Information Terminal

33 Information System

40 Network

50 Target Device

60 Electric Appliance

1. A control system comprising:
a transmitter including a manual operation unit and configured to, when the manual operation unit is operated, cause self-power generation to send an operation signal via wireless communication; and
a receiver system configured to, when receiving the operation signal via wireless communication, control a plurality of target devices associated with the operation signal.

2. The control system according to claim 1, wherein
the receiver system includes
a receiver configured to receive an operation signal from the transmitter; and
a server or a cloud computing system connected to the receiver via a network.

3. The control system according to claim 1, wherein
the transmitter includes a piezoelectric device configured to convert mechanical energy produced when the manual operation unit is operated, into electric energy.

4. The control system according to claim 1, wherein
the receiver system is configured to control the plurality of target devices in a predetermined order.

5. The control system according to claim 1, wherein
the receiver system is configured to, only when receiving an operation signal from the transmitter within a valid time period corresponding to the operation signal, control a plurality of target devices associated with the operation signal.

6. The control system according to claim 1, wherein
the transmitter is configured to, when receiving identification information via intra-body communication, send the identification information via wireless communication.

7. A transmitter comprising a manual operation unit and configured to, when the manual operation unit is operated, cause self-power generation to send an operation signal via wireless communication.

8. A receiver system configured to, when receiving an operation signal via wireless communication, control a plurality of target devices associated with the operation signal.
